(19) United States
(12) Patent Application Publication
(10) Pub. No.: US 2002/0074677 A1
(43) Pub. Date: Jun. 20, 2002

(54) Method and device for producing plastic hollow bodies

(75) Inventors: Dietmar Przytulla, Kerpen (DE); William Lima, Monmouth Beach, NJ (US)

Correspondence Address: PENNIE & EDMONDS LLP, 1667 K STREET NW, SUITE 1000, WASHINGTON, DC, 20006

(73) Assignee: MAUSER WERKE GMBH, Bruhl (DE)

(21) Appl. No.: 10/028,909

(22) Filed: Dec. 28, 2001

Related U.S. Application Data
(63) Continuation of application No. 09/486,540, filed on Feb. 29, 2000.
(60) Provisional application No. 60/111,893, filed on Dec. 10, 1998.

(30) Foreign Application Priority Data
May 28, 1998 (DE) DE 298 09 489.4
May 28, 1999 (EP) PCT/EP99/03723

(51) Int. Cl. B32B 1/02; B29C 49/04; B29C 49/22; B29C 49/78; B29D 22/00

(52) U.S. Cl. 264/40.1; 428/36.5; 264/515; 264/540; 425/532; 425/381; 425/466

(57) ABSTRACT

This invention relates to a method and a device for producing blow-molded plastic hollow bodies. The device is of an enhanced design which avoids the shortcomings of traditional blow-molding technology. The extrusion die according to this invention is adjustable for different settings to produce different, partly overlapping wall thicknesses of the parison blank in order to compensate for the insufficiencies inherent in blow-molding and to obtain a finished blow-molded product with as consistent and uniform a wall thickness as possible, with an overlay, for instance in vertical wall sections, of evenly spaced longitudinal ribs. A technical concept is introduced whereby, as a novel process, the two conventional measures used to achieve a uniform wall thickness in the finished blow-molded hollow body are complemented by an additional, third step which makes it possible to produce containers whose hollow bodies are provided with targeted, intentional and reproducible irregular wall-thickness patterns.

### RELATED APPLICATIONS

This is a Continuation under 35 USC 120 of U.S. Application Ser. No. 09/486,540, filed Feb. 29, 2000.

### FIELD OF THE INVENTION

This invention relates to a method and a device for producing plastic hollow bodies, and to a plastic hollow body produced therewith.

### BACKGROUND OF THE INVENTION

In the production of plastic hollow bodies such as cylindrical bung-equipped barrels or lid-top drums with an essentially circular lid or top surface, it is usually desirable to obtain a finished container with a consistent, uniform wall thickness, given that a thin or starved area will always constitute a weak spot of the container. This is a particular problem in blow-molding where the hot parison blank exiting from the extruder nozzle is automatically elongated or stretched as a function of its progressively greater length and weight, leading to a thinning of the wall thickness of the blank during the extrusion, while in the blow-forming process it is exposed to strongly varied stretch forces especially in the areas near the flash and shear edges perpendicular to the blank and at a 90° angle to the plane of separation of the blow mold. These inevitable phenomena are typically compensated for by correspondingly controlling the rate at which the parison blank exits the extruder nozzle. This, however, requires special ancillary equipment for the extruder, with dual adjustments for the annular extrusion nozzle as well as special techniques and control programs for sectional wall-thickness adjustment of the extruded parison in adaptation to the specific, varying container shape to be produced. A number of nozzle-control systems for sectional or partial wall-thickness control (PWDS) have been on the market.

The British patent 1,107,628 already describes a method and a device by means of which rib-shaped protrusions or, viewed in the circumferential direction, varying wall thicknesses can be molded into the extruded parison blank. The inside of the finished blow-molded hollow body is thus provided with reinforcing ribs extending in an axial direction. However, that earlier extrusion system does not permit other adjustments such as a progressive increase in the wall thickness of the parison as a function of its length.

Plastic containers intended for industrial use for the storage and transportation especially of hazardous substances require a special permit for which they must pass appropriate quality tests (such as cold drop tests, internal pressure tests, stacking load tests etc.). In the stacking load test the plastic containers are exposed to a progressively increasing pressure up to the point where the hollow-body buckles. The compressive load on the hollow body creates compression stress in the vertical side walls. That compression stress leads initially to a certain circumferential expansion and then, if there is excessive stress in the areas which cannot expand outwards, to an inward buckling. The stacking load will cause the wall areas close to the bottom to bulge (so-called elephant foot), changing the transitional radius between the vertical wall and the horizontal bottom. In practice, these manifestations of inadequate stacking strength in the form of buckling and bulging are often encountered when plastic barrels are stacked and especially when these are filled with hot liquids and immediately stacked in layers of three or four or when stacked for an extended time period.

The U.S. Pat. No. 4,257,527 already describes a large-volume plastic barrel (having a capacity of 55 US gallons or about 208 liters) where the vertical wall area of the cylindrical body is reinforced by several longitudinal ribs (see FIG. 4 thereof). These longitudinal ribs are produced in the blow-molding of a parison blank, having a constant, uniform wall thickness, merely by providing the blow mold with axial grooves. The thickness of the container wall in the circumferential direction remains unchanged. Where the longitudinal ribs, molded relatively deep into the container wall, transition into the upper and/or lower perimeter, this configuration causes deep pockets or nests from which highly viscous materials can be removed only with great difficulty, making the barrel unsuitable for multiple reuse. Moreover, these transition points at the perimeter constitute structurally weak spots in the event the barrel is exposed to a mechanical load.

### SUMMARY OF THE INVENTION

It is the objective of this invention to provide an improved method and a corresponding device for producing plastic hollow bodies, and especially plastic containers which, while retaining their smooth external wall surface and an unchanged operational container weight, i.e. without increasing the net material weight compared to that of a corresponding conventional container, offer greater stacking-load strength especially when filled with hot liquids.

The method applied according to this invention for producing blow-molded plastic hollow bodies in a blow molding tool incorporating an extruder, an extrusion die with a circular runner and an appropriate blow mold proper, whereby during the extrusion of the parison from the extrusion die the nozzle and mandrel gap are adjusted for a specifically targeted wall thickness of the extruded blank, is particularly characterized in that, through the sequential or simultaneous action of three differently profiled, separately adjustable nozzle/mandrel-gap control elements, it is possible to obtain thickness/thinness settings which vary in controlled, selectable fashion over the circumference and length of the parison blank. This multiple adjustability of the extrusion is of great significance for large-volume industrial containers (for instance 220-liter barrels), it is unique at this juncture and unmatched in terms of the quality of the containers.

The containers thus produced, having vertical walls, an essentially horizontal top panel or clampable lid, including at least one filler and drain opening, and a corresponding bottom panel, are provided exclusively on the inside of their vertical walls with multiple, mutually spaced ribs, leaving the exterior wall surface uniformly smooth and unchanged. Plastic barrels configured in this fashion offer visibly improved stacking strength while not in any way complicating their handling (e.g. gripping by barrel loaders, or lateral rolling of the barrel).

The implementation of this invention provides for alternating variations of the thickness of neighboring wall sections, with the transitions from thinner to thicker wall sections and vice versa being in the form of uniformly decreasing and increasing waveforms on the inside of the wall. In a preferred embodiment the wall thickness of all the thicker, strip-like wall regions is the same and the thinner, strip-like wall regions are of an identically reduced thickness.

The plastic container according to this invention is produced by blow molding, a process in which a parison blank extruded through a circular nozzle is expanded in a blow mold, whereupon, by means of correspondingly controlled nozzle settings, the blank is adjusted for a consistently increasing wall thickness in the axial direction while, again by appropriate nozzle control, the blank sections exposed to the highest stretch factors at the points of the top and bottom panels of the container which are located at a 90° angle relative to the separation plane are adjusted for a greater wall thickness and, again by appropriate nozzle control, the parison is provided on the inside and/or outside with longitudinally protruding ribs in such fashion that the finished product completed in a blow mold, having a smooth surface for the lateral i.e. vertical wall sections, is provided at least axially on the container wall with parallel, neighboring, strip-like wall regions alternating between a larger and a lesser thickness (a ribbed drum).

The new triple or multiple nozzle/mandrel-gap control elements according to this invention permit in advantageous fashion numerous new applications for large-volume, blow-molded plastic components of all types (e.g. motor-vehicle accessories and the like). When the third nozzle/gap control element DS II is suitably configured, the invention will lend itself particularly well to the production of industrial blow-molded components, including for instance top-quality plastic fuel tanks (KKBs) for the automotive industry.

The plastic container with reinforced vertical wall sections per this invention may be produced as an essentially sealed hollow body (for instance a bung-equipped barrel with two lateral bung holes, or a drum with screw-on lid=“L-ring HOT” with a larger screw-on cover), or an open-top hollow body with a cover lid and clamping ring (e.g. a standard lid-top barrel or a Vanguard FRH drum).

With the design per this invention, incorporating internal reinforcement ribs without otherwise changing the wall thickness obtained using two conventional control elements, it has been possible with great success for instance in the USA to fill hot liquids into lid-top barrels (Vanguard FRH drums, filling temperature of content about 180° F.) having a barrel weight of about 22 lbs, to store the barrels for three days in a heat chamber at temperatures between 140 and 160° F. and then stack them four-high, without observing any of the traditional signs of deformation.

The axial ribbing in the vertical wall regions increases the rigidity of the hollow body, i.e. the denting resistance of the barrel shell while the ribs along the axial radii in the transition from the wall to the top or bottom panel prevent a curling of the bottom corners.

When hollow bodies with axial, longitudinal ribs per this invention are subjected to an axial load, the circumferential stress is evenly distributed. When filled with hot liquids, and after these have cooled off, Vanguard drums with ribbed wall reinforcement display substantially better resistance to negative pressure conditions. The exterior wall of the barrel, its smoothness unchanged, permits easy marking or labeling. It also allows for easy cleaning of the barrels and thus for multiple reuse.

The ribs are formed by partially increasing the wall thickness. The thicker the ribs, the disproportionately greater the resistance of the hollow-body shell to kinking, bulging and buckling or to a curling of the bottom edges; indeed, the section modulus is augmented by a power of three as the height or thickness of the ribs increases.

The barrels and drums according to this invention do not have a greater operational net weight than conventional barrels; there is only a redistribution of the container wall material, in each case from a “thin strip” to an adjoining “thick strip” (=rib). In the past, buckling, bulging or, respectively, the curling of the bottom edges of hollow bodies has been avoided by increasing the overall wall thickness of the container and thus its material net weight.

In various embodiments in which the reinforcement ribbing is provided only on the inside of the hollow-body wall, the ribs may be configured as follows:

in an axial direction over only a specific partial region or

over the entire length or height of the cylindrical wall;

along the radii, i.e. transitions from the vertical wall to the horizontal top or bottom panel;

in the disc-shaped top and/or bottom panels.

### BRIEF DESCRIPTION OF THE DRAWINGS

This invention is explained in more detail in the following description of implementation examples with the aid of schematic drawings in which

FIG. 1 is a sectional cutoff view of an extrusion die according to this invention;

FIG. 2 is a schematic wall-thickness control program for a specifically targeted wall thickness setting for the extruded parison blank;

FIG. 3 shows a longitudinal section and three cross sections of a blank;

FIG. 4 shows a finished, blow-molded hollow body and its cross section;

FIG. 5 shows a partial cross section of a parison;

FIG. 6 shows a partial cross section of a rib-reinforced canister wall;

FIG. 7 shows a partial cross section of a rib-reinforced barrel wall;

FIG. 8 shows a longitudinal section of a rib-reinforced canister;

FIG. 9 is a top view and a partial cross-sectional view of the canister per FIG. 8;

FIG. 10 shows a longitudinal section of another rib-reinforced canister;

FIG. 11 is a top view and a partial cross-sectional view of the canister per FIG. 10;

FIG. 12 is a lateral view and partial cross-sectional view of a standard lid-top barrel with a rib-reinforced barrel wall;

FIG. 13 shows two cross sections of the wall of the barrel per FIG. 12;

FIG. 14 is a lateral view and partial cross-sectional view of a Vanguard FRH lid-top barrel with a rib-reinforced wall;

FIG. 15 shows two cross sections of the wall of the barrel per FIG. 14;

FIG. 16 is a lateral view and partial cross-sectional view of a sealed L-ring barrel with a rib-reinforced wall;

FIG. 17 shows two cross sections of the wall of the barrel per FIG. 16; and

FIG. 18 is a perspective illustration of a plastic subcontainer for a pallet container, with rib-reinforced walls.

### DETAILED DESCRIPTION OF THE INVENTION

FIG. 1 shows part of an extrusion die 10 with three adjustable nozzle/mandrel-gap control elements D0, DS I in conjunction with DF and DF II in the “nozzle gap open” mode, extruding a parison blank 22. Centered in the extrusion die 10 is an axially adjustable mandrel support 12 to the bottom of which a truncated-cone-shaped mandrel 14 is attached, in easily removable i.e. interchangeable fashion, as the first nozzle/mandrel-gap control element Dₙᵤₗₗ (D_{zero}=D 0). An enclosure 16 surrounds the extrusion die. The enclosure 16 houses a hollow-cylindrical reservoir 18 in which the molten plastic material fed from one or several extruders into the extrusion die is evenly distributed and stored. The reservoir 18 connects to a circular nozzle gap 20 the inside of which is delimited by the mandrel 14, i.e. by the first nozzle/mandrel-gap control element D 0 while on the outside it is delimited by an enclosure-mounted nozzle/ring DF and two adjustable nozzle/mandrel-gap control elements, the nozzle gate valve 1=DS I and the nozzle gate valve 2=DS II. Like the adjustable mandrel 14, the two axially adjustable control elements DS I and DS II are attached to the extrusion-die enclosure in easily detachable and thus interchangeable fashion. The axial setting and precise positioning of the adjustable nozzle/mandrel-gap control elements may be operated for instance by a hydraulic mechanism or by electric motors such as small servo motors. The enclosure-mounted nozzle ring DF as well is attached to the extrusion-die enclosure in easily removable and interchangeable fashion, primarily to permit, at the time of a product changeover with attendant exchange of the blow-mold halves, an equally quick exchange of the appropriately contoured, product-specific circular runners and nozzle-gap control elements.

In the extrusion die 10 illustrated in FIG. 1, the nozzle/mandrel-gap control elements are in the “nozzle gap open” mode, meaning that the mandrel D 0 is lowered a certain distance, the nozzle gate valve=control element DS I is in its bottom-most position and the gate valve DS II is not all the way up. Corresponding arrows indicate the respective available path lengths for the adjustment of the control elements. In the extrusion die 10, the surfaces of the gap-delimiting fixed nozzle/circular runner DF and the control element DS II are contoured while the gap-delimiting surfaces of the mandrel D 0 and the control element DS I are completely smooth.

In the operating mode shown, the nozzle gap 20 is delimited on the outside by the lower, inner, smooth edge of the nozzle gate valve DS I and on the inside by the axially adjustable mandrel 14. The extruded parison 22 has a uniformly thin circumference. The contouring profiles of the fixed nozzle/circular runner DF and of the control element DS II are not engaged in their active position. To engage the contouring profile of the nozzle/circular runner DF, one simply moves the gate valve DS I with its smooth lower edge in an upward direction. To fully engage the serrated profile of the gate valve DS II, the gate valve DS II can be lowered a certain distance. The circular serration, in this case with evenly spaced teeth 24 and interstitial spacings 26, is outlined in the marginal illustration. When the serration engages circumferentially in the exiting parison, the teeth 24 displace the extruded plastic material sideways into the adjoining interstitial spaces 26.

To engage the fixed, enclosure-mounted circular runner DF, the control element DS I and the control element DS II are jointly moved upward a certain distance (see arrow), preventing these two control elements from engaging in the extruded parison blank 22.

The die gap 20 is now delimited by the mandrel 14 and the fixed, contoured circular runner DF. At this point the parison 22 exiting from the nozzle gap will no longer be of a uniform circumferential thickness but will be somewhat thinner in two mutually opposite regions (mold parting plane of the blow mold) than in the corresponding, 90°-shifted regions of the parison. This type of double-oval setting of the nozzle gap, or oval wall-thickness setting in mutually opposite regions of the parison, is typical for blow-molded blanks with flat top and bottom panels. In the process, the two mutually opposite regions of the parison having thicker walls are positioned between the open blow-mold halves in such fashion that they are formed into the horizontal container wall sections, situated at a 90 angle relative to the mold-parting plane, which are exposed to the largest stretch factors or expansion vectors of the plastic material. In other words, the purpose is to obtain a uniform wall thickness in the finished container, so that the corners of the container wall which are subjected to high stretch and strain levels are no thinner than the other wall sections.

The device (=extrusion die) according to this invention permits the selection of different, partly overlapping settings for varying wall thicknesses of the parison blank, thus compensating for the process-related shortcomings inherent in blow-molding and achieving in the finished product (container or hollow body) as consistent and uniform a wall thickness as possible with an overlay of evenly spaced longitudinal ribs (reinforcing ridges).

This invention introduces a novel process whereby the two conventional measures used to achieve a uniform wall thickness in the finished blow-molded hollow body are complemented by an additional, third step which makes it possible to produce containers whose hollow bodies are provided with targeted, intentional and reproducible irregular wall-thickness patterns. Different variations of embodiment of the extrusion die according to this invention are described in more detail in the parallel PCT Application PCT/EP99/01398 filed by the same claimant.

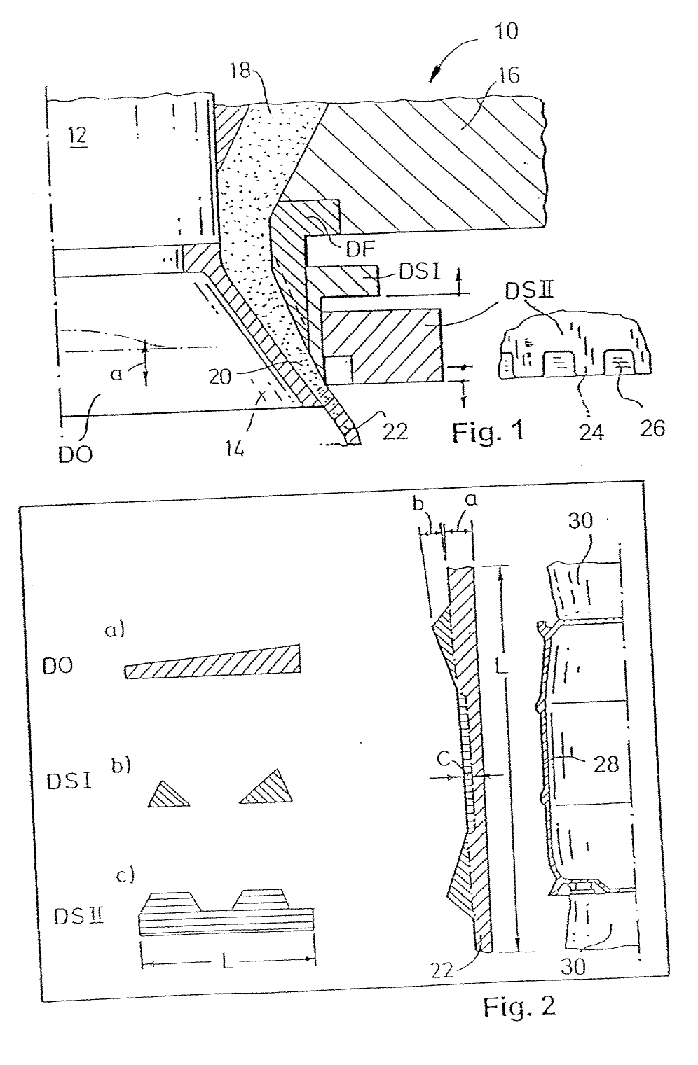

FIG. 2 is a schematic illustration of a wall-thickness control program for a specifically targeted wall thickness setting over the length of the extruded parison. Shown on the left are the individual programs a), b) and c) for the control elements D 0, DS I and DS II; in the center a parison wall of the extruded blank; and on the far right the blow-molded product in the form of a tilted L-ring barrel 28 with the flash sections 30 not yet removed.

In program a), the gate valve D 0 i.e. axially adjustable mandrel 14, serves to slowly and progressively open up the cross section of the nozzle so as to obtain a continuously progressive increase of the wall thickness over the length of the parison blank 22. In program b). the second control element, i.e. the gate valve DS I in conjunction with the contoured, enclosure-mounted circular nozzle ring DF, serves to set a partly larger circumferential wall thickness in the two longitudinal sections of the extruded blank (near the ultimate flash pinch-off perpendicular to the blank) by a corresponding enlargement of the cross section of the nozzle as additional plastic material is fed in (no displacement). In program c), the third control element i.e. adjustable gate valve DS II with the serrated-contour profile serves to select an alternating thick/thin wall-thickness pattern, creating longitudinal ribs by the partial, lateral displacement of the plastic material in the nozzle gap. The result, as illustrated in the center, is a strongly varied wall-thickness pattern over the length of the parison, the pattern being adapted to the respective type of product (in this case an L-ring drum with ribbing in the vertical wall section).

In contrast to conventional control elements by means of which the partly thicker parison sections intended for the highest stress points are produced by pushing aside plastic material in the nozzle gap for those parison sections which are moved into the mold-parting plane, whereby the displaced material is pushed into the thick-wall sections at a 90° angle to the mold-parting plane, the design of the extrusion device according to this invention, allowing the gate valve DS I to be moved upward, frees up the double-oval profile of the fixed nozzle ring DF, so that at that point more plastic material can flow where it is really needed. A lateral displacement over great path lengths has its disadvantages in that the memory effect of the plastic material will negatively affect the straight flow of the parison, causing the cross section of the blank at its starting point to be out of round. When the initial point of the parison is not cleanly fed over the blowing mandrel and the parison-expanding mandrel, it will lead to frequent jamming of the system.

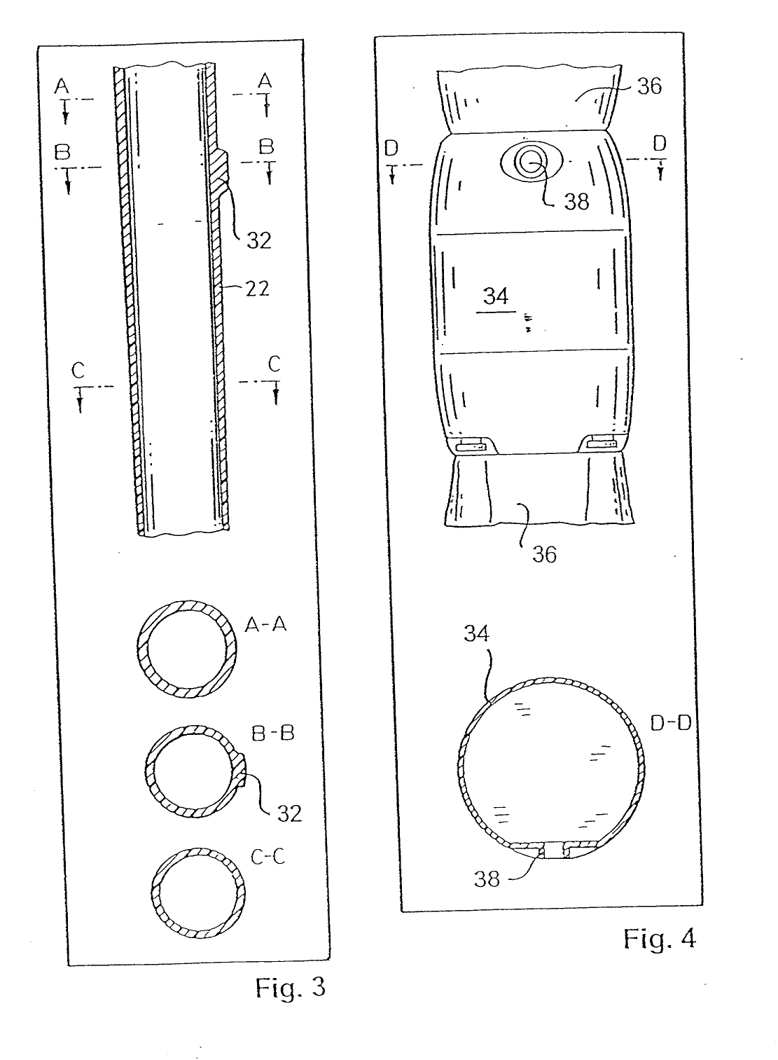

To more clearly illustrate a custom profile, the top part of FIG. 3 shows a longitudinal section, the bottom part three cross sections, of a simplified parison blank 22 for a nonstandard blow-molded hollow body in the form of a plastic fuel container (KKB) 34. The parison blank 22 is thicker on top along the line A-A than it is at the bottom along line CC. For simplicity's sake, the partially thicker, beaded areas obtained in sub-program b) by means of the gate valve DS I are not shown. In the cross-sectional plane B-B, one single, additional bead 32 serves to accommodate a lateral opening and fitting in the finished container. The plastic fuel container 34, with lateral fitting 38, and with the flash sections 36 not yet removed, is illustrated in FIG. 4, as a lateral view on the top and a cross-sectional view on the bottom.

The extrusion die according to this invention, with three separate adjustment control systems, is particularly suitable for producing these custom configurations with local material accumulations (as along line B-B in FIG. 3) such as the one required for the KKB 34 in the area of the fitting (line D-D in FIG. 4).

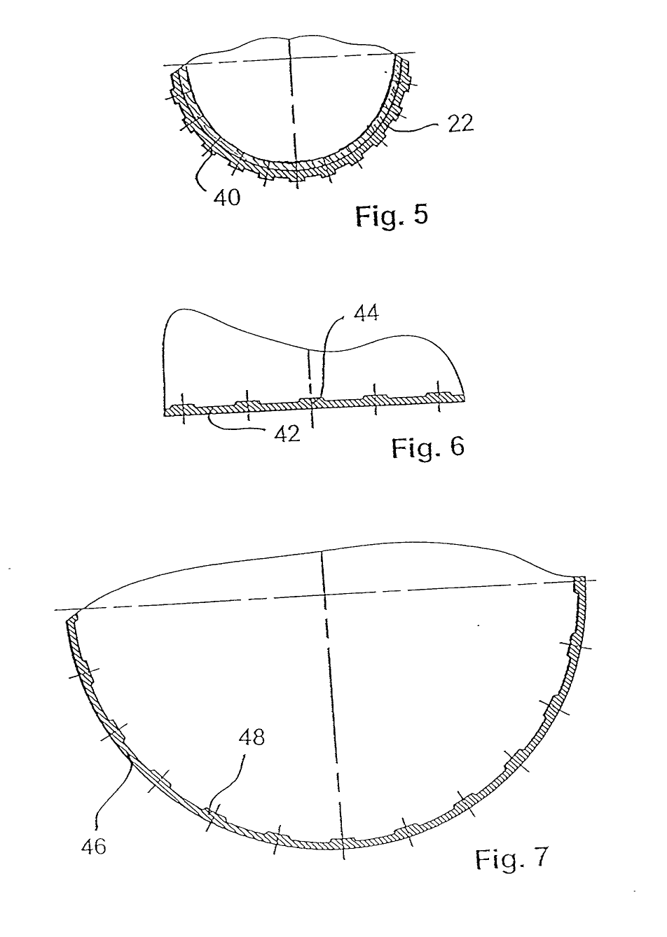

FIG. 5 is a partly cross-sectional view of a parison blank 22 with evenly spaced external ribs 40. When this parison is expanded into a finished hollow body, the ribbed parison 22 will lie against the smooth inner wall of the blow-mold and the external ribs 40 will be defined in the inner wall of the finished hollow body. FIG. 6 shows a corresponding section of a straight container wall 42 (for instance that of a canister or of the inner container of an IBC pallet container) with internal ribs 44. FIG. 7 shows a corresponding partial section of a cylindrical container wall for a Vanguard lid-top barrel 46 with internal ribs 48.

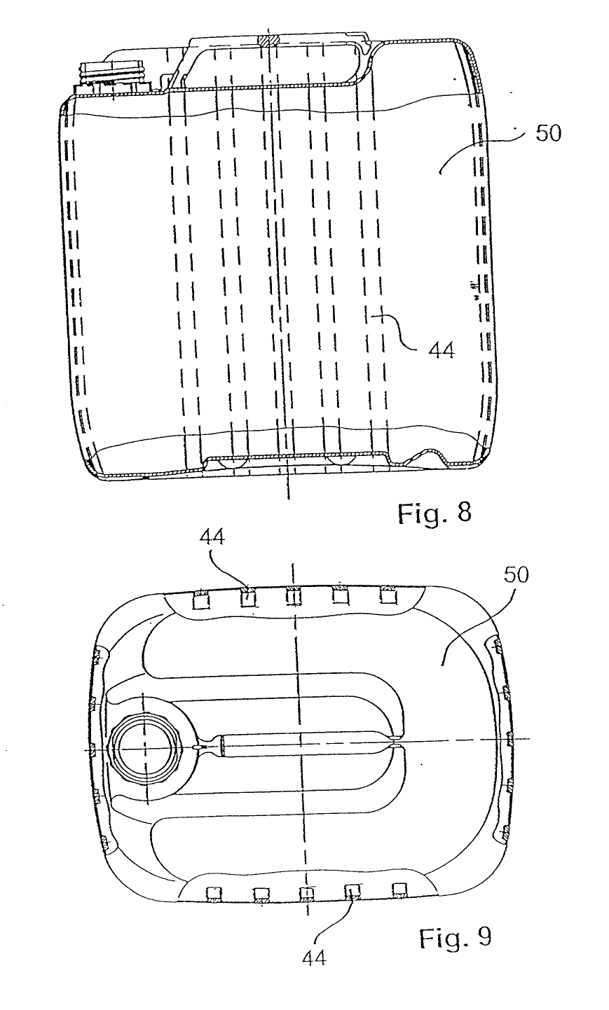

FIG. 8 is a partial cross-sectional view of an implementation example in the form of a canister 50 with internal ribs 44 along the level i.e. straight walls. The top view of this canister, in FIG. 9, shows in the partial, sectional illustration that the axial ribs 44 transition over a short horizontal distance into the bottom of the canister, whereas there are no ribs in the corners of the canister. The axial ribs 44 serve to reinforce the straight wall sections against excessive bulging when there is a buildup of internal pressure in the canister.

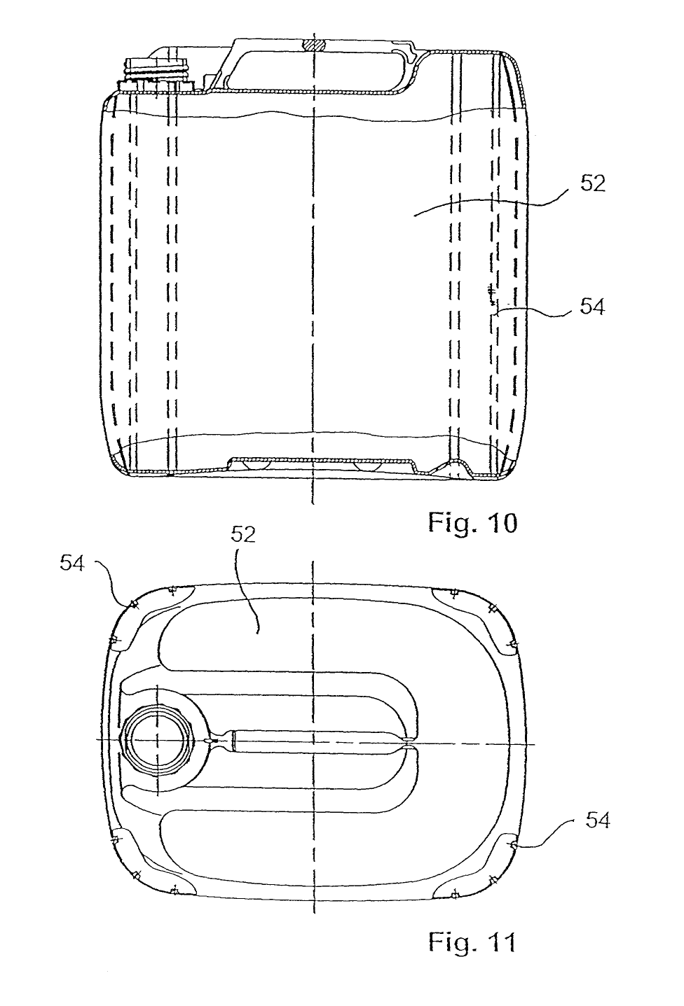

In contrast thereto, the corners of the canister 52 depicted in FIG. 10 are provided with suitable internal ribs 54. These corner ribs 54 can be seen in FIG. 11 which is a partly sectional top view of the corners; they enhance the stacking load capacity and reduce any curling (“elephant feet”) of the corners of this type of canister.

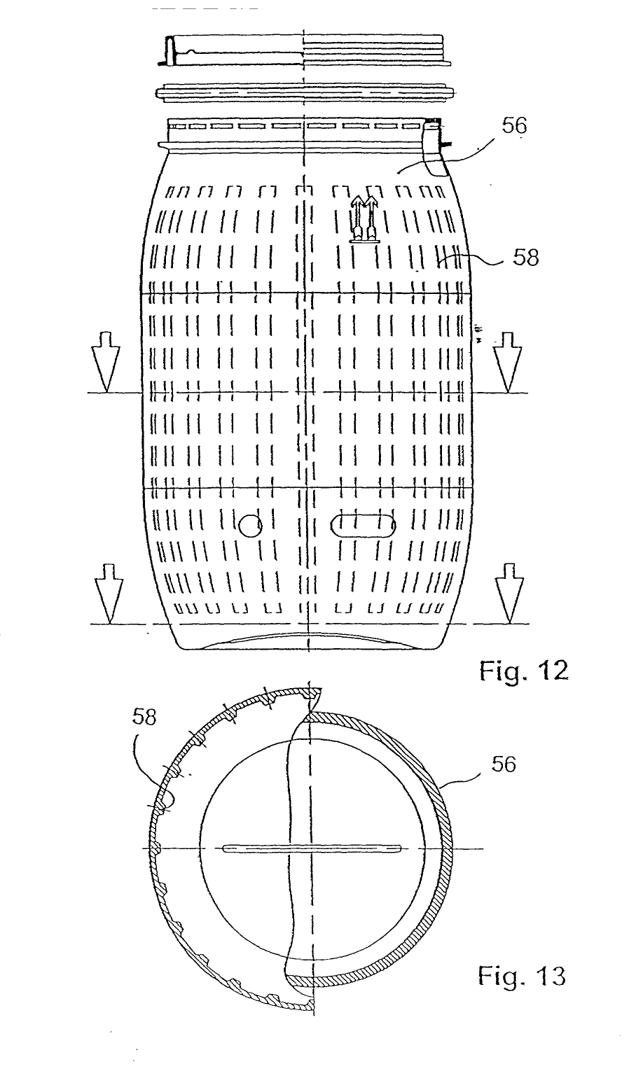

FIG. 12 shows a lid-top barrel 56 of the globally familiar standard type developed by Mauser in 1975. The vertical wall of the barrel body is provided with multiple, mutually spaced, strip-like ribs 58 which extend all the way into the convex areas of the barrel body. In FIG. 13 the cross-sectional view in the left half of the diagram shows the barrel wall with the internal ribs 58 and in the right half of the diagram the barrel wall without ribs just above the barrel bottom.

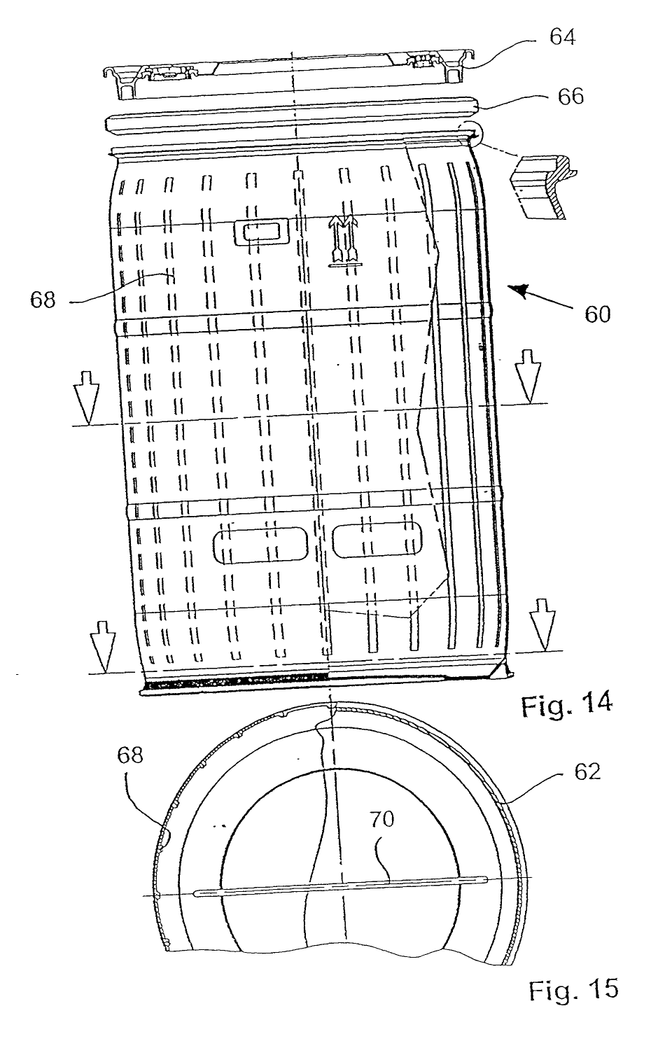

FIG. 14 is a side view of the preferred embodiment of a Vanguard FRH lid-top barrel 60 with the barrel body 62, the lid 64 and the clamping ring 66. On the inside wall only, the barrel body 62 is provided with multiple, parallel, strip-like ribs 68, while the outer surface of the wall is evenly smooth without any modification. FIG. 15 is again a cross-sectional view showing in the left half of the diagram the barrel wall with internal ribs 68 and in the right half of the diagram the wall area without ribs just above the bottom of the barrel. The transversal line indicated in the barrel bottom represents the pinch-off weld 70 of the parison blank in the mold-parting plane of the blow-mold.

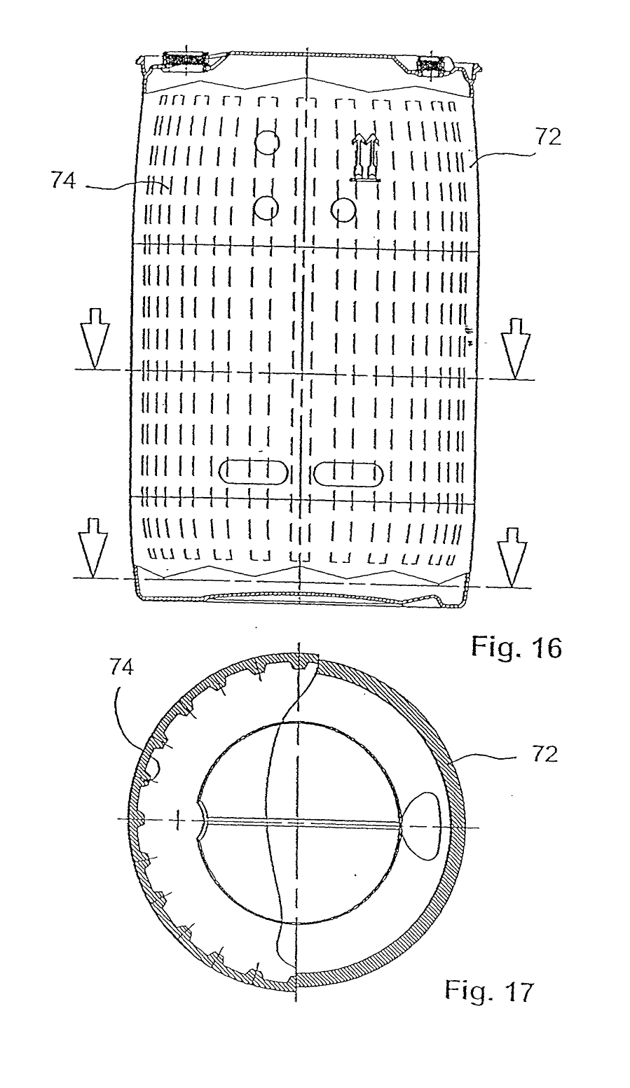

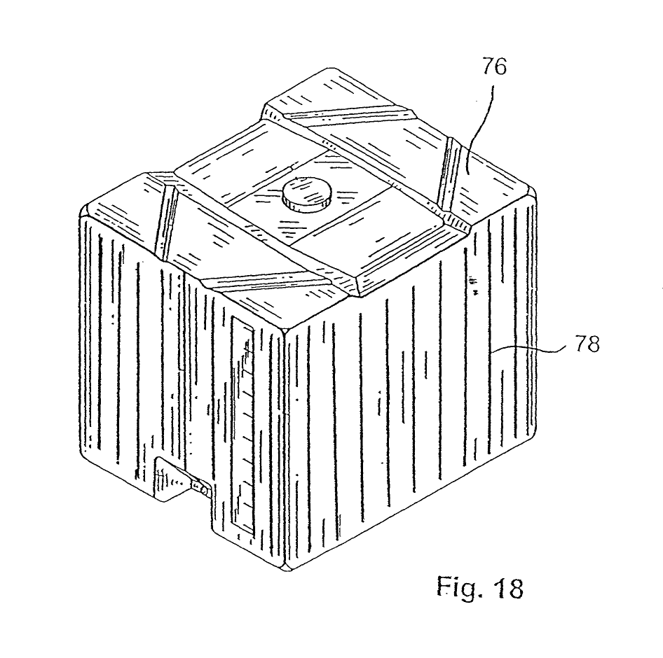

FIG. 16 shows another implementation example in the form of a closed bung-type barrel 72 with two lateral bung fittings in the top panel and internal ribs 74 along the vertical walls. In L-ring barrels of this type, the internal ribs 74 shown in FIG. 17 enhance the stacking-load strength of the barrel body especially when filled with hot liquids.

As the last implementation example, FIG. 18 illustrates a plastic inner container 76 as used in pallet containers. The internal ribs 78 outlined on the flat walls reinforce these walls and prevent the walls of empty containers from caving in.

In a comparison for instance between a conventional plastic barrel having a net weight of 10 kg and a plastic barrel according to this invention, likewise with a net weight of 10 kg, the cross-sectional mass of the extruded parison will be identical for both. The only difference in the case of the plastic barrel according to this invention is that the plastic material is displaced from a thin section to the right and left and redistributed into the two neighboring thick sections or ribs. A key benefit of this invention lies in the fact that for a plastic barrel according to this invention the blow-mold employed in each case need not be modified in any way, retaining its smooth inner surface.

The diameter of a 55-gallon Vanguard lid-top barrel is approximately 23″ (590 mm). The width of the thick strips or ribs is about 1″ (25 mm), their wall thickness about 0.2″ (5.0 mm); the thin strips, i.e. those of a regular wall thickness, are about 2″ (50 mm) wide and about ⅛″ (3.2 mm) thick. The spacing or thin strip between two neighboring ribs should be at least twice or several times the width of a rib.

For a barrel diameter of 23″ (590 mm) the preferred number of ribs is around 32. Containers with a smaller diameter should have fewer, containers with a larger diameter should have a larger number of internal reinforcing ribs. Optimal parameter selection can result in an improvement of the stacking load strength of the containers according to this invention, especially when filled with hot liquids, compared to conventional containers, by as much as 5% to 20%.

This invention is equally applicable to containers with a circular cross section and to containers with a rectangular cross section (such as large canisters and square containers).

In sealed bung-type barrels (such as L-ring barrels) where the upper perimeter of the barrel wall is provided with a solid handling ring (i.e. L-ring), the strip-like ribs along the vertical wall preferably extend only to just below the handling ring rather than into the L-ring or the top panel. The distance between the end of the ribs (i.e. tapering off of the thick region) and the handling ring should be between about ¾″ (20 mm) and 2⅓″ (60 mm).

For a large-capacity container, for instance a 58-gallon L-ring barrel, the wall thickness in the thin wall regions between the ribs should be about 0.078″ (2 mm) to 0.14″ (3.5 mm); the wall thickness of the ribs should be between about ⅛″ (3 mm) and ¼″ (6 mm). At no point should the wall thickness be less than 0.078″ (2 mm). Viewed in the circumferential direction, the width of a rib should be about 0.2″ (5 mm) to 0.8″ (20 mm); the width of the thinner wall regions between the ribs should be about 0.8″ (20 mm) to 3.2″ (80 mm).

List of Reference Numbers

| | |
|---|---|
| 10 | Extrusion die |
| 12 | Mandrel support D 0 |
| 14 | Mandrel, centered |
| 16 | Enclosure |
| 18 | Reservoir |
| 20 | Nozzle gap |
| 22 | Parison blank |
| 24 | Serration tooth |
| 26 | Interstitial space |
| 28 | L-ring barrel |
| 30 | Flash sections |
| 32 | Thick region |
| 34 | Plastic fuel container KKB |
| 36 | Flash sections |
| 38 | Fittings |
| 40 | External ribs (22) |
| 42 | Straight wall |
| 44 | Internal ribs (42) |
| 46 | Lid-top barrel body |
| 48 | Internal ribs (46) |
| 50 | Canister, straight |
| 52 | Canister corner |
| 54 | Corner ribs (52) |
| 56 | Lid-top barrel, standard |
| 58 | Internal ribs (56) |
| 60 | Vanguard lid-top barrel |
| 62 | Barrel body |
| 64 | Barrel lid |
| 66 | Clamping ring |
| 68 | FRH ribs |
| 70 | Pinch-off weld |
| 72 | Bung-type barrel |
| 74 | Internal ribs (72) |
| 76 | IBC inner container |
| 78 | Internal ribs (76) |

Nozzle/mandrel-gap control elements:

| | |
|---|---|
| D 0 | Central mandrel |
| D F | Enclosure-mounted contoured circular runner |
| DS I | Gate valve I with smooth edge |
| DS II | Gate valve II with contoured profile |

1. A method for producing a blow molded plastic hollow body having a plurality of vertical ribs on an inner surface thereof, comprising:
extruding an annular parison having axially extending ribs formed along an outer surface thereof, a wall thickness of the annular parison varying along its length;
introducing the parison into a blow mold;
expanding the parison in a blow molding step, such that the outer surface of the parison is pressed against the inner surface of the blow mold, thereby causing the axially extending ribs to be formed as vertical ribs on an inner surface of a hollow body formed in the blow mold.

2. The method according to claim 1, comprising
extruding the axially extending ribs on the parison in four spaced-apart areas;
providing a substantially rectangular blow mold having first and second pairs of parallel side walls joined together at rounded corner areas; and
forming the vertical ribs in four spaced apart areas of an inner surface of a substantially rectangular hollow body, during the blow molding step.

3. The method according to claim 2, comprising forming the vertical ribs only in the rounded corner areas, central regions of the first and second pairs of sidewalls being substantially devoid of the vertical ribs.

4. The method according to claim 2, comprising forming the vertical ribs only in central regions of the first and second pairs of sidewalls, the rounded corner areas being substantially devoid of the vertical ribs.

5. The method according to claim 1, comprising:
forming a bead on the outer surface of the parison, during the extruding step; and
subsequently forming a lateral opening in the blow molded plastic hollow body from said bead.

6. The method according to claim 1, comprising:
extruding additional plastic material to thereby form thicker annular walls at longitudinally spaced apart first and second portions of the parison; and
pinching off the hollow body formed in the blow mold at said first and second portions, after the blow molding step.

7. A method for producing a blow-molded plastic hollow body comprising the steps of:
providing a parison extrusion device having an extrusion end provided with an adjustable nozzle gap formed between cooperating first, second and third control elements on a first side of the nozzle gap and an adjustable mandrel on a second, opposite side of the nozzle gap, wherein the second, and third control elements are selectively and independently movable relative to the first control element;
extruding a tubular parison blank of a thermoplastic material from said parison extrusion device such that:
a wall thickness of the extruded parison increases along its length,
a wall thickness of the extruded parison around its circumference is increased, relative to adjacent areas, in at least two spaced apart longitudinal zones near ultimate pinch-off edges perpendicular to the parison;
a plurality of thickened, longitudinally extending ribs are formed at radially spaced apart predetermined locations along a length of the parison;
introducing the parison blank between open blow-mold halves of a blow-mold; and
expanding the parison blank into a finished hollow body with the aid of a gaseous pressure medium.

8. The method according to claim 7, comprising:
adjusting said first control element to progressively widen the nozzle gap and thereby progressively increase a wall thickness of the extruded parison over its length; and
adjusting the second control element to thereby enlarge the nozzle gap and thereby increase the wall thickness at said two spaced apart longitudinal zones; wherein:
the third control element is provided with a serrated tooth/interstitial-gap profile configured to partially laterally displace plastic material in the nozzle gap.

9. The method according to claim 8, comprising:
adjusting the third control element to thereby form at least one additional thick spot in at least one preselectable location along the parison.

10. The method according to claim 9, comprising:
forming a lateral fitting in the hollow plastic body from said at least one additional thick spot.

11. The method according to claim 8, wherein gap-delimiting surfaces of the mandrel and the second control element are smooth while gap-delimiting surfaces of the first and third control elements are contoured.

12. The method according to claim 7, comprising:
creating a bead on the parison during the extruding step; and
creating a lateral fitting from the bead during the expanding step.

13. A parison extrusion device having an extrusion end provided with an adjustable nozzle gap formed between cooperating first, second and third control elements on a first side of the nozzle gap and an adjustable mandrel on a second, opposite side of the nozzle gap, wherein:
the first, second and third control elements are adjacent to one another with the first control element being farthest from a nozzle exit from which a parison is extruded, the third control element is closest to the nozzle exit and the second control element is position between the first and third control elements; and
the second, and third control elements are independently movable relative to the first control element.

14. The parison extrusion device according to claim 13, wherein the mandrel is mounted on an axially adjustable mandrel support.

15. The parison extrusion device according to claim 13, wherein the mandrel has a truncated cone shape.

16. The parison extrusion device according to claim 13, wherein:
the third control element is provided with a serrated tooth/interstitial-gap profile configured to partially laterally displace plastic material in the nozzle gap.

17. The parison extrusion device according to claim 13, wherein:
gap-delimiting surfaces of the mandrel and the second control element are smooth while gap-delimiting surfaces of the first and third control elements are contoured.

18. The parison extrusion device according to claim 13, wherein a bottom-most inner edge of the third control element is positioned no lower than a bottom-most outer edge of the mandrel.

19. The parison extrusion device according to claim 13, wherein:
the mandrel is mounted on an axially adjustable mandrel support, the mandrel having a truncated cone shape;
the third control element is provided with a serrated tooth/interstitial-gap profile configured to partially laterally displace plastic material in the nozzle gap;
gap-delimiting surfaces of the mandrel and the second control element are smooth while gap-delimiting surfaces of the first and third control elements are contoured; and
a bottom-most inner edge of the third control element is positioned no lower than a bottom-most outer edge of the mandrel.

20. A parison extrusion device comprising:
an adjustable annular parison exit nozzle having a circular nozzle/mandrel-gap control element; and
adjacent first, second and third differently contoured, exchangeable nozzle/nozzle-gap control elements spaced apart from the circular nozzle/mandrel-gap control element to thereby define an annular extrusion gap; wherein
the second and third control elements are selectively and independently adjustable to engage a plastic material being extruded into an exiting parison.

21. The parison extrusion device according to claim 20, wherein:
the third control element is provided with a serrated tooth/interstitial-gap profile configured to partially laterally displace plastic material in the nozzle gap.

22. The parison extrusion device according to claim 20, wherein:
gap-delimiting surfaces of the nozzle/mandrel-gap control element and the second control element are smooth while gap-delimiting surfaces of the first and third control elements are contoured.

23. The parison extrusion device according to claim 20, wherein a bottom-most inner edge of the third control element is positioned no lower than a bottom-most outer edge of the nozzle/mandrel-gap control element.
